(19) United States
(12) Patent Application Publication
(10) Pub. No.: US 2007/0195375 A1
(43) Pub. Date: Aug. 23, 2007

(54) Network scanner device

(75) Inventor: Toshimitsu Morimoto, Kanagawa (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/707,945

(22) Filed: Feb. 20, 2007

(30) Foreign Application Priority Data
Feb. 21, 2006 (JP) JP 2006-044306
Feb. 21, 2006 (JP) JP 2006-044307

(51) Int. Cl. H04N 1/00

(52) U.S. Cl. 358/407

(57) ABSTRACT

Image data read by the scanner device is transmitted to arbitrary devices via a network. A plurality of destination addresses is input (Step S1). The image data read by the scanner device are transmitted to at least one destination address (shared folder address) from among the plurality of inputted destination addresses (Step S4), and image data information are transmitted to the other destination addresses (e-mail addresses) (Step S5). The image data information includes the file name of the image data and the destination address to access the image data.

### CROSS-REFERENCE TO RELATED APPLICATIONS

This application claims priority to Japanese Patent Application Nos. 2006-044306 and 2006-044307 filed on Feb. 21, 2006. The entire disclosure of Japanese Patent Application Nos. 2006-044306 and 2006-044307 is hereby incorporated herein by reference.

### BACKGROUND OF THE INVENTION

1. Field of the Invention

The present invention generally relates to a network scanner device. More specifically, the present invention relates to a network scanner device that reads images and the like of an original document, and transmits the image data read by the scanner device to arbitrary devices via a network.

2. Background Information

A network scanner device, which is also called a push type scanner device, is an image reading device as disclosed in, for example, Japanese Patent Application Laid-open No. 2003-179714 and Japanese Patent Application Laid-open No. 2002-77504.

If using the device as disclosed in Japanese Patent Application Laid-open No. 2003-179714 or Japanese Patent Application Laid-open No. 2002-77504, the image data read from an original document can be transmitted via a network to an arbitrary device connected to the network, for example, one's own personal computer or the personal computer or a particular person, and so on. Also, according to Japanese Patent Application Laid-open No. 2002-77504, the image data read from the original document can also be transmitted to a plurality of devices connected to the network (simultaneous transmission). Further, in Japanese Patent Application Laid-open No. 2002-57832 a fax server used as a network scanner is disclosed. When this fax server has distributed the received image data or the read image data to a file server, the fax server notifies the client PC of the distribution.

In the devices of Japanese Patent Application Laid-open No. 2003-179714 or Japanese Patent Application Laid-open No. 2002-77504, when the image data read by the network scanner device are transmitted to a plurality of devices via the network, a large volume of data flows in the network as a result of this transmission. Transmission of a large volume of data such as this consumes time and energy.

The device disclosed in Japanese Patent Application Laid-open No. 2002-57832 distributed the received data to a device (file server) separate from one's own personal computer (client PC). Therefore, it was necessary to access the device to which the image data was distributed from one's own personal computer via the network to view the image data, which required time.

However, when distributing image data read by a network scanner device to a plurality of destinations, there are occasions when the image data are needed at a certain destination, but for other destinations it is sufficient if the file name of the image data and the destination personal computer (specifically, the shared folder address) are known with no need to examine the detailed content of the image data. For these occasions, the image data were also transmitted equally to the plurality of destinations. Therefore, there was the problem that time and energy necessary for the transmission were wastefully consumed.

In view of the above, it will be apparent to those skilled in the art from this disclosure that there exists a need for an improved network scanner device. This invention addresses this need in the art as well as other needs, which will become apparent to those skilled in the art from this disclosure.

### SUMMARY OF THE INVENTION

Based on this background, it is an object of the present invention to provide a network scanner device capable of reducing the transmission time and energy by transmitting image data from the network scanner device to the destinations that require the image data, and transmitting information to access the image data to the other destinations.

Also, based on this background, it is a main object of the present invention to provide a network scanner device capable of appropriately transmitting the necessary data to the necessary destinations from the network scanner device and reducing the transmission time and energy.

A network scanner device according to a first aspect of the present invention is provided to achieve these objects. The network scanner device can be connected to a network and can transmit the image data that have been read via the network. The network scanner has an image reading unit, an input unit, a first transmission unit, and a second transmission unit. The input unit inputs destination addresses to transmit the image data read by the image reading unit via the network to arbitrary devices connected to the network. The first transmission unit transmits the image data read by the image reading unit to a destination address that specifies a specific device having a shared folder from among a plurality of inputted destination addresses, corresponding to a plurality of destination addresses input by the input unit. The second transmission unit transmits image data information that includes the file name and destination address of the image data transmitted by the first transmission unit to the remainder of the plurality of input destination addresses apart from the destination address of the specific device having a shared folder.

A network scanner device according to a second aspect of the present invention is the network scanner device according to the first aspect, wherein the second transmission unit uses e-mail to transmit data.

A network scanner device according to a third aspect of the present invention is the network scanner device according to a first aspect, wherein at least one of the addresses to which the image data read by the image reading unit are transmitted is the first input destination address.

A network scanner device according to a fourth aspect of the present invention is provided to achieve the aforementioned objects. The network scanner device can be connected to a network and can transmit the image data that have been read via the network. The network scanner has an image reading unit, an input unit, a first transmission unit, and a second transmission unit. The input unit inputs destination addresses to transmit the image data read by the image reading unit via the network to arbitrary devices connected to the network. The first transmission unit transmits the image data read by the image reading unit to a destination address that specifies a specific device having a shared folder from among a plurality of inputted destination addresses, corresponding to a plurality of destination addresses input by the input unit. The second transmission unit transmits reduced display data of the image data to the remainder of the plurality of input destination addresses apart from the destination address of the specific device having a shared folder.

A network scanner device according to a fifth aspect of the present invention is the network scanner device according to the fourth aspect, wherein at least one of the addresses to which the image data read by the image reading unit are transmitted is the first input destination address.

According to the invention of the first aspect, the image data read by the image reading unit are directly transmitted to the shared folder for destinations that need to examine in detail the content of the image data. On the other hand, image data information are transmitted for destinations that only need to know that the image data have been created and that do not need to know the detailed content of the image data. This image data information includes the file name and destination address of the image data read by the image reading unit. The volume of image data information is small, so only a small amount of time and energy is required for transmission. Also, when necessary it is possible for the destinations that have been sent the image data information to access the shared folder and read the image data that were read by the image reading unit.

Therefore, according to the invention of the first aspect, the image data are transmitted to destinations that require the image data when transmitting image data via a network to arbitrary devices from the network scanner device. Information (image data information) to access the image data is transmitted to other destinations. Therefore it is possible to provide a scanner device with superior transmission efficiency that can be used with superior transmission time and energy efficiency.

In the invention according to the second aspect, the second transmission unit can transmit using e-mail that contains the image data information. If transmitting an e-mail containing the image data information is used as means to notify the image data information, it is possible to transmit the image data information to personal computers connected to a network such as the Internet. The volume of data in an e-mail containing image data information is small, so only a small amount of time and energy is required to transmit this e-mail.

Also, information to access the image data is included by including the image data information in the e-mail at destinations to which this e-mail is transmitted, so when necessary it is possible to view easily the image data that has been transmitted to the shared folder via the network.

In the invention according to the third aspect, the image data read by the image reading unit are transmitted to the destination address input first. Therefore, for example, by inputting first the destination address corresponding to the shared folder of one's own personal computer, it is possible to transmit the image data to one's own personal computer. In this way, the image data can be viewed from one's own personal computer, so it is possible to provide a device with good usability to transmit image data.

According to the invention of the fourth aspect, the image data read by the image reading unit are directly transmitted to the shared folder for destinations that need to examine in detail the content of the image data. On the other hand, reduced display data of the image data are transmitted for destinations that only need to know that the image data have been created, and that do not need to know the detailed content of the image data. The data volume of the reduced display data is small so the time and energy required for transmission is small. Also, when necessary, it is possible for the destinations that have been sent the reduced display data to access the shared folder and to read easily the image data that were read by the image reading unit.

Therefore, according to the invention of the fourth aspect, when transmitting image data via a network to arbitrary devices from the network scanner device, and when simultaneously transmitting the same image data to various destinations, image data of the necessary size are transmitted to the necessary destinations. Therefore it is possible to provide a scanner device with good transmission efficiency and that can be used with good transmission time and energy efficiency.

In the invention according to the fifth aspect, the image data read by the image reading unit is transmitted to the destination address input first. Therefore it is possible to provide a device with good usability to transmit image data.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a view of a schematic block diagram of a network connection structure that includes a network scanner device according to a first preferred embodiment of the present invention;

FIG. 2 is a view of a flowchart showing an example of a control operation of a control unit of the network scanner device;

FIG. 3 is a view of a flowchart showing another example of the control operation of the control unit;

FIG. 4 is a view of a schematic block diagram of a network connection structure that includes a network scanner device according to a second preferred embodiment of the present invention;

FIG. 5 is a view of a block diagram of the MFP configuration; and

FIG. 6 is a view of a flowchart showing an example of the control operation of the control unit.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

The following is a detailed explanation of a first embodiment of the present invention with reference to the appended drawings.

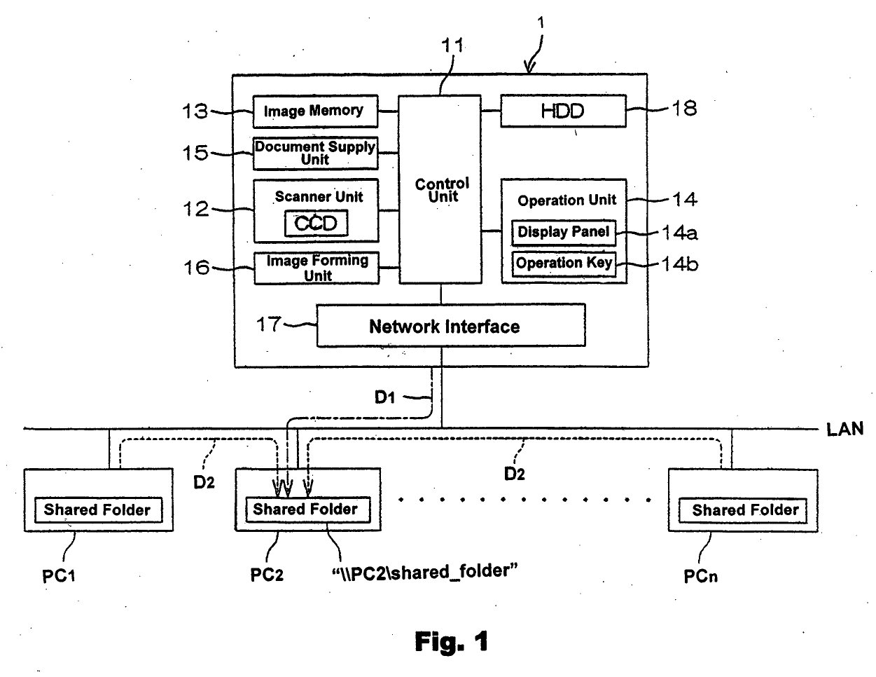

FIG. 1 is a view of a schematic block diagram of a network connection structure that includes a network scanner device according to a first preferred embodiment of the present invention. Here, a multi-function peripheral (hereafter referred to as MFP) 1 is used as the network scanner device.

The MFP 1 is connected to personal computers PC1 through PCn via a network such as for example a local area network (LAN). The personal computers PC1 through PCn are, for example, the personal computers of each employee within a certain company. In this kind of network connection configuration, the MFP 1 transmits image data read by the MFP 1 or image data information via the network to specific personal computers, and transmits electronic mail.

The MFP 1 includes a control unit 11 having a microcomputer or the like, and a scanner unit (image reading unit) 12 having a charge coupled device (CCD) or similar that is controlled by the control unit 11. The control unit 11 is connected to a network interface 17, and is connected to a LAN via the interface 17. Also, the MFP 1 includes an image memory 13 to store image data read by the scanner unit 12. The image memory 13 is controlled by the control unit 11.

The MFP 1 includes a document supply unit 15. When for example the MFP 1 reads a document set in the document supply unit 15, the document is preferably supplied one page at a time to the scanner unit 12 by the document supply unit 15. Further, when copying in addition to reading a document, an image forming unit 16 is operated, and the document image read by the scanner unit 12 is transferred onto a sheet.

Further, the MFP 1 includes an operation unit (input unit) 14 so that users can carry out many types of operations. The operation unit 14 includes a display panel 14a and operation keys 14b. By operating the operation keys 14b, it is possible to select or input the names of personal computers as destinations (including computer names controlled by the network system), input the addresses of shared folders as destination addresses, input e-mail addresses, and so on. Also, the display panel 14a is provided to display operation data and other contents, and is controlled by the control unit 1. Signals input at the operation unit 14 are sent to the control unit 11.

The MFP 1 also includes an HDD (hard disk drive) 18. The HDD 18 stores as a destination address list personal computer names (for example, “PC2”), the address of the shared folder of the personal computer “PC2” (for example, “\\P2\shared_folder”), the e-mail address set for the personal computer “PC2,” and other related information. In this way, when a user selects a computer name via the operation unit 14, the control unit 11 can call up from the destination address list the shared folder address and the e-mail address associated with that personal computer name.

For destinations that need to examine in detail the contents of the image data itself (for example, personal computer PC2), the control unit 11 directly transmits (arrow symbol D1) the image data read by the scanner unit 12 to the shared folder (“\\PC2\shared_folder”). Thus, a first transmission unit is preferably made of the control unit 11 and the network interface 17.

On the other hand, for destinations (for example, personal computers PC1, PCn) that do not need to know the details of the image data, and for which it is sufficient to know that the image data have been transmitted, the control unit 11 transmits an e-mail or other message containing the image data information. Image data information can include the file name of the image data that was read, the storage address (in this case, “\\PC2\shared_folder”), transmission time, password, and so on. Thus, a second transmission unit is preferably made of the control unit 11 and the network interface 17. The volume of image data information is small, so only a small amount of time and energy is required for transmission. Also, the persons that receive the image data information, in other words the users of personal computers PC1 to PCn, can access the shared folder when necessary using this information so the image data read by the scanner unit can be easily seen (arrow symbol D2).

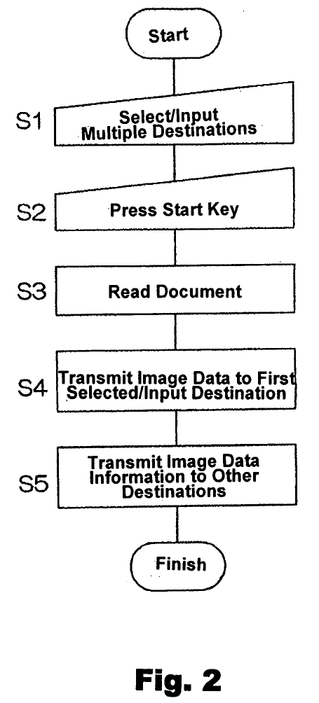

FIG. 2 is a view of a flowchart showing an example of the control operation of the control unit. Here, the operation (control operation) of the MFP 1 is explained in accordance with the flow in FIG. 2, while referring also to FIG. 1.

First, in order to transmit image data read by the scanner unit 12 via the network to, for example, one's own personal computer and to those of two superiors, subordinates, or colleagues A and B (hereinafter abbreviated as superiors), one's own personal computer PC2 and the personal computers of superiors A and B (PC1 and PCn) are specified.

Specifically, the operation unit 14 of the MFP 1 is operated, and the image data or image data information are selected from the data stored in the destination address list and input (Step S1) to a plurality of destinations (for example, one's own personal computer PC2, superior A's personal computer PC1, and superior B's personal computer PCn) for sending. Here, the control unit 11 calls up the destination addresses corresponding to the input destinations from the destination address list. Of course, it should be apparent from this disclosure that the destination addresses corresponding to the destinations may be directly input by, for example, a user.

Next, to start reading the document, a start key that is provided as one of the operation keys 14b is pressed (Step S2), and a signal to start reading is sent to the control unit 11. Then the document that is set in the document supply unit 15 is read in order by the scanner unit 12 (Step S3).

Next, the image data are transmitted to the destination address corresponding to the destination (in this case, the shared folder address “\\PC2\shared_folder” of the personal computer PC2) initially input in Step S1 (Step S4: the arrow symbol D1 in FIG. 1).

Next, the image data information is notified (transmitted) to the destinations apart from the destination in Step S4, using for example e-mail (in this case, the e-mail set in the personal computers PC1 and PCn) (Step S5).

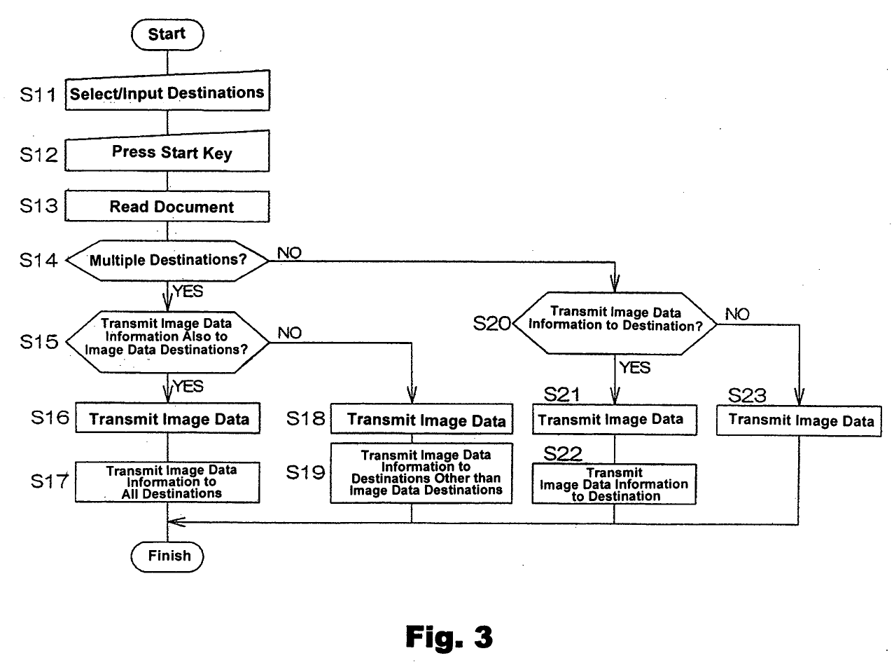

FIG. 3 is a view of a flowchart showing another example of the control operation of the control unit. Here, the operation (control operation) of the MFP 1 is explained in accordance with the flow in FIG. 3 while referring also to FIG. 1.

In Step S11, in order to transmit the image data read by the scanner unit 12 via the network, for example, to one's own personal computer and to those of one's superiors A and B, one's own personal computer PC2 and the personal computers of one's superiors A and B (PC1 and PCn) are specified.

Specifically, the operation unit 14 of the MFP 1 is operated, and the image data or image data information are selected from the data stored in the destination address list and input to a plurality of destinations (for example, one's own personal computer PC2, superior A's personal computer PC1, and superior B's personal computer PCn) for sending. Here, the control unit 11 calls up the destination addresses corresponding to the input destinations from the destination address list. Of course, it should be apparent from this disclosure that the destination addresses corresponding to the destinations may be directly input by, for example, a user.

Next, to start reading the document, a start key that is provided as one of the operation keys 14b is pressed (Step S12), and a signal to start reading is sent to the control unit 11. Then the document that is set in the document supply unit 15 is read in order by the scanner unit 12 (Step S13).

Next, it is determined whether the multiple destinations have been input at Step S11 (Step S14).

If it is determined that multiple destinations have been input at Step S11 (at Step S14: Yes), it is determined whether to notify the destinations to which the image data are sent of the image data information (Step S15).

If in Step S15 it is set that destinations that are sent the image data are to be notified of the image data information (Step S15: YES), the image data are transmitted to the destination addresses (in this case, the shared folder address “\\PC2\shared_folder” of the personal computer PC2) corresponding to the destinations specified for transmission of the image data (Step S16: arrow symbol D1 in FIG. 1).

Next, the image data information is notified (transmitted) to all destinations input at Step S11, using, for example, e-mail (in this case, the e-mail set for personal computers PC1, PC2, and PCn) (Step S17).

If in Step S15 it is set that destinations that are sent the image data are not to be notified of the image data information (Step S15: NO), the image data are transmitted to the destination addresses (in this case, the shared folder address “\\PC2\shared_folder” of the personal computer PC2) corresponding to the destinations specified for transmission of the image data (Step S18: arrow symbol D1 in FIG. 1).

Next, the image data information is notified (transmitted) to the destinations apart from the destinations in Step S18, using, for example, e-mail (in this case, the e-mail set in the personal computers PC1 and PCn) (Step S19).

On the other hand, in Step S11, there are cases when in order to transmit image data read by the scanner unit 12 via the network to, for example, one's own personal computer, one's own personal computer PC2 that is connected to the network is specified. In this case, the operation unit 14 of the MFP 1 is operated, and the destination (for example, one's own personal computer PC2) to which the image data or image data information is transmitted is selected and input from the data stored in the destination address list. Here, the control unit 11 calls up the destination address corresponding to the input destination from the destination address list.

In this case, it is determined at Step14 that multiple destinations have not been input (Step S14: NO), so it is determined whether to send the image data information to the destination address (Step S20).

If it is set to send the image data information to the destination to which the image data are to be sent (Step S20: YES), the image data are transmitted (Step S21: arrow symbol D1 in FIG. 1) and the image data information is notified (transmitted) to the destination address (in this case, the shared folder address “\\PC2\shared_folder” of the personal computer PC2) corresponding to the destination specified for transmission of the image data (Step S22).

If in Step S20 it is set not to send the image data information to the destination to which the image data are to be sent (Step S20: NO), only the image data are transmitted to the destination (Step S23: arrow symbol D1 in FIG. 1).

Using the control as described above, the MFP 1 transmits the image data to the destinations that require the image data, and notifies (transmits) the image data information to access the image data to the other destinations using for example e-mail. The volume of image data information is small, so only a small amount of time and energy is required for transmission. Also, when necessary it is possible for the destinations that have been sent the image data information to access the shared folder and to read the image data that were read by the scanner unit 12. In this way, the transmission efficiency is good, and a network scanner device that can efficiently use the transmission time and energy can be provided.

Also, the MFP 1 may be connected to a personal computer via a network including the Internet. At this time, as in the embodiment described above, if sending e-mail containing the image data information is used as means for transmitting the image data information, it is possible to notify the personal computer connected to the Internet using this e-mail. Also, the volume of data in an e-mail containing image data information is small, so only a small amount of time and energy is required to transmit this e-mail. At destinations to which this e-mail is transmitted, information to access the image data is included by including the image data information in the e-mail. Thus, it is possible to access the shared folder via the network, when necessary it is possible to view easily the image data that have been transmitted to the shared folder.

Furthermore, when multiple destinations are selected and input as in Step S1 of FIG. 2, the shared folder corresponding to the first input personal computer may be specified as the destination address, and the e-mail addresses corresponding to the second and subsequently input personal computers may be specified as destination addresses. In this way, the image data that are read is transmitted to the first input destination address. Therefore, by for example first inputting the destination address corresponding to the shared folder of one's own personal computer, the image data can be transmitted to one's own personal computer. In this way, it is possible to view easily the image data from one's own personal computer, so it is possible to provide a device with good usability for transmitting image data.

### Second Embodiment

A second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

### Second Embodiment

The following is a detailed explanation of a second embodiment of the present invention with reference to the attached drawings.

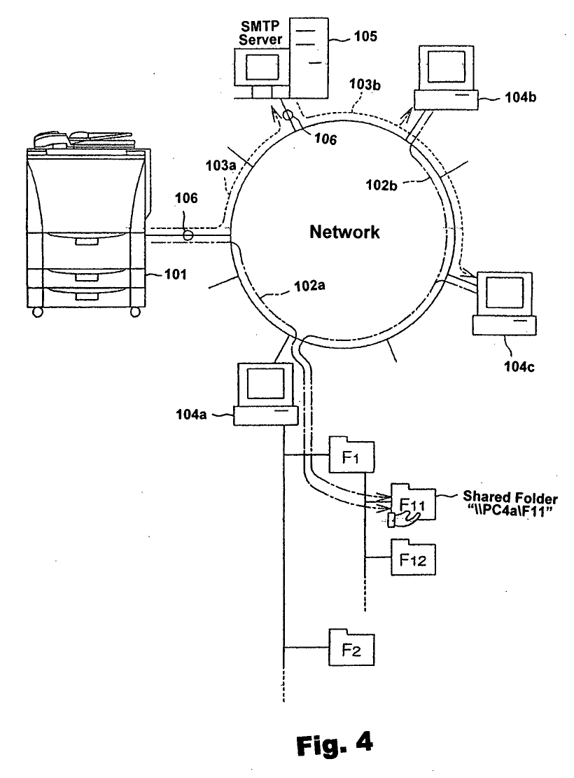

FIG. 4 is a view of a schematic block diagram of a network connection structure that includes a network scanner device according to a second preferred embodiment of the present invention. Here, an MFP 101 is used as the network scanner device.

The MFP 101 is connected to a network such as a LAN or the Internet, via a gateway server and firewall 106. The MFP 101 is mutually connected to external personal computers (hereafter simply referred to as “PC”) 104a to 104c, and a simple mail transfer protocol (SMTP) server 105 via this network. In this kind of network connection configuration, the MFP 101 transmits the image data that are read to a plurality of PCs 104 via the network by operating the MFP 101. Transmission of image data to a plurality of PCs 104 is described later.

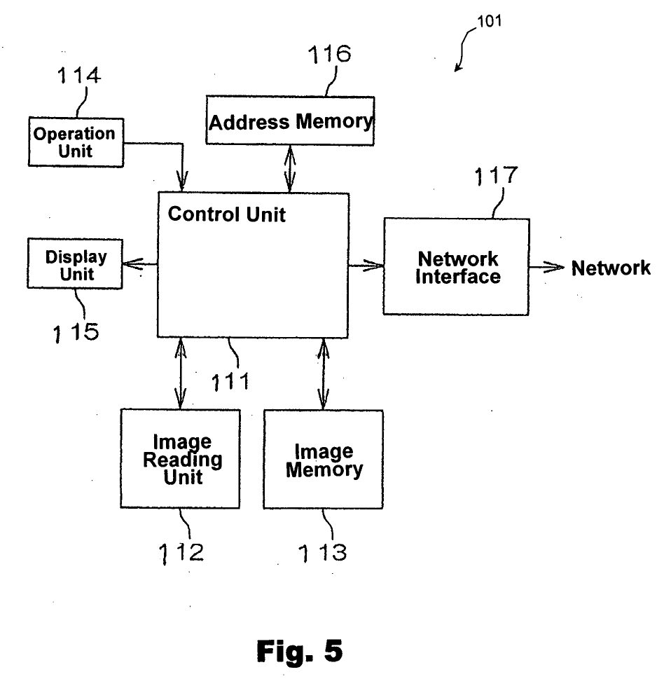

FIG. 5 is a view of a block diagram of the MFP 101 configuration. Here, the block diagram of the MFP 101 configuration is explained referring also to FIG. 4.

The MFP 101 includes a control unit 111 having a microcomputer or the like, and an image reading unit 112 that is controlled by the control unit 111. Also, the MFP 101 includes an image memory 113 to store image data read by the image reading unit 112. The image memory 113 is controlled by the control unit 111.

Also, the MFP 101 includes an operation unit 114 so that users can carry out many types of operation. By operating the operation unit 114, it is possible to input and to select shared folder addresses and e-mail addresses as destination addresses. Signals input at the operation unit 114 are sent to the control unit 111. The MFP 101 also includes a display device 115 that displays operation data and other contents. The display device 115 is controlled by the control unit 111. The MFP 101 further includes an address memory 116. The address memory 116 stores PC names (for example, PC 104a), the address of the shared folder of the PC “\\PC4a\F11,” the e-mail address set for the PC, and other information related to the PC name (PC104a). In this way, by selecting a PC from the operation unit 114, the control unit 111 can call up the shared folder address and the e-mail address associated with the PC name from the address memory 116. Thus, the operation unit 114 and the address memory 116 are included in the input unit.

Also, the control unit 111 is connected to a network interface 117, and is connected to a network via the interface 117. The first and second transmission units are made of the control unit 111 and the interface 117.

The control unit 111 directly transmits the image data read by the image reading unit 112 to their shared folder (the arrow symbol 102a in FIG. 4) for destinations (PC 104a in FIG. 4) that need to examine in detail the contents of the image data itself.

On the other hand, the control unit 111 transmits thumbnail data that have been processed to minimize the image data that were read as an attachment to e-mail (the arrow symbol 103a, 103b in FIG. 4) for destinations (PC 104b, 104c in FIG. 4; for example the PCs of colleagues in a research group or specific groups, and so on) that do not need to know the detailed contents of the image data and for which it is sufficient to know that the image data have been sent. The data volume of this thumbnail data is small, so the time and energy required for transmission is small. Also, when necessary it is easy to view (the arrow symbol 102b in FIG. 4) the actual image data read by the MFP 101 from a destination to which thumbnail data have been sent by accessing the shared folder, so a person that is interested in the thumbnails can view the image data in detail.

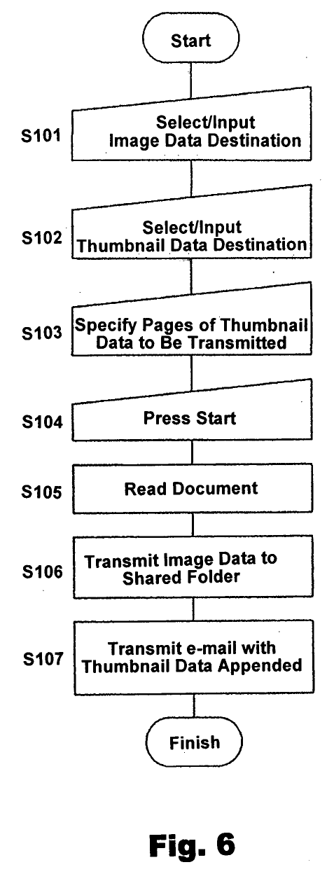

FIG. 6 is a view of a flowchart showing an example of the control operation of the control unit 111. Here, the operation (control operation) of the MFP 101 is explained in accordance with the flow shown in FIG. 6, while referring to both FIG. 4 and FIG. 5.

First, to transmit the image data read by the image reading unit 112 via the network, the PC 104 connected to the network is specified.

Specifically, in Step S101, the operation unit 114 of the MFP 101 is operated, and the destination address (the shared folder address “\\PC4a\F11” of the PC 104a in FIG. 4) to which the image data is to be sent is selected and input from the destination addresses stored in the address memory 116. Of course, it should be apparent from this disclosure that this destination address may be directly input by, for example, a user. This image data are the actual data read by the image reading unit 112. Also, this destination (PC 104a in FIG. 4) is a destination that needs to examine in detail the content of the actual image data.

On the other hand, in Step 102, the operation unit 114 of the MFP 101 is operated, and the destination addresses (the e-mail addresses set for PC 104b, 104c in FIG. 4) to which thumbnail data is to be sent are selected and input from the destination addresses stored in the address memory 116. Of course, it should be apparent from this disclosure that these destination addresses may be directly input by for example a user. This thumbnail data are data that have been image processed by the control unit 111 to be displayed as reduced. Also, these destinations (PC 104b, 104c in FIG. 4) are destinations for which it is sufficient to know that the image data have been transmitted, and for which there is no need to know the contents of the image data in detail.

Next, the thumbnail data pages to be appended as data are specified (Step S103) for the destination addresses (e-mail addresses) input in Step S102. Here, as thumbnail data for the desired pages are selected, for example the first page that was read, or all pages, and so on. Then the start key is pressed (Step S104) to start reading the document, a signal to start reading is sent to the control unit 111, and the document set in the image reading unit 112 is read in order (Step S105).

Next, the image data read by the image reading unit 112 are transmitted to the destination address (shared folder address) and input in Step S101 (Step S106: arrow symbol 102a in FIG. 4).

Next, the read image data are processed to reduce the data and to create thumbnail data. Then the pages of thumbnail data specified in Step S103 are appended to an e-mail and sent to the destination addresses (e-mail addresses) input in Step S102 (Step S107: arrow symbols 103a, 103b in FIG. 4). At this time, information on the shared folder address “\\PC4a\F11” in which the image data that were read is stored, file name of the image data, password, and so on, may also be added to the thumbnail data and sent together with the e-mail.

The control as described above is carried out, so when the image data are transmitted via the Internet from the MFP 101 to a plurality of PCs 104, and when simultaneously transmitting image data read from the same document, image data of the necessary size are transmitted to the necessary destinations. In this way, the MFP 101 has good transmission efficiency, and it is possible to use the MFP 101 for transmission with good time and energy efficiency.

The at least one destination address to which the image data that were read is transmitted may be first destination address input. In this case, the two processes in Step S101 and Step S102 become a single process of selecting and inputting multiple destination addresses. For example, when selecting and inputting destination addresses from the PC names stored in the address memory 116, the shared folder address associated with the first selected PC 104 is called up from the address memory 116 and selected as the destination address. For the second and subsequently selected PCs 104, the e-mail addresses associated with these PCs are called up from the address memory 116 and selected as the destination addresses. In this way, the actual image data are sent to the first input destination address from among the plurality of destination addresses selected and input, so it is possible to provide a device with good usability to send image data.

Terms that are expressed as “means-plus function” in the claims should include any structure that can be utilized to carry out the function of that part of the present invention.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including,” “having,” and their derivatives. Also, the terms “part,” “section,” “portion,” “member,” or “element” when used in the singular can have the dual meaning of a single part or a plurality of parts. As used herein to describe the present invention, the following directional terms “forward, rearward, above, downward, vertical, horizontal, below, and transverse” as well as any other similar directional terms refer to those directions of a image forming device equipped with the present invention. Accordingly, these terms, as utilized to describe the present invention should be interpreted relative to an image forming device equipped with the present invention as used in the normal riding position. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A network scanner device being configured to be connected to a network and to transmit image data that have been read via the network, comprising:
an image reading unit;
an input unit being configured to input destination addresses to transmit the image data read by said image reading unit via the network to arbitrary devices connected to the network;
a first transmission unit being configured to transmit the image data read by said image reading unit to a destination address specifying a specific device having a shared folder from among a plurality of inputted destination addresses, corresponding to a plurality of destination addresses input by said input unit; and
a second transmission unit being configured to transmit image data information including a file name and destination address of the image data transmitted by said first transmission unit to the remainder of said plurality of input destination addresses, different from said destination address of said specific device having said shared folder.

2. The network scanner device according to claim 1, wherein said second transmission unit uses e-mail to transmit data.

3. The network scanner device according to claim 1, wherein at least one of said addresses to which the image data read by said image reading unit is transmitted is the first input destination address.

4. A network scanner device being configured to be connected to a network and to transmit image data that have been read via the network, comprising:
an image reading unit;
an input unit being configured to input destination addresses to transmit the image data read by said image reading unit via the network to arbitrary devices connected to the network;
a first transmission unit being configured to transmit the image data read by said image reading unit to a destination address specifying a specific device having a shared folder from among a plurality of inputted destination addresses, corresponding to a plurality of destination addresses input by said input unit; and
a second transmission unit being configured to transmit reduced display data of the image data to the remainder of said plurality of input destination addresses, different from the destination address of said specific device having said shared folder.

5. The network scanner device according to claim 4, wherein at least one of said plurality of addresses to which the image data read by said image reading unit is transmitted is the first input destination address.
